(19) United States
(12) Patent Application Publication
(10) Pub. No.: US 2024/0150685 A1
(43) Pub. Date: May 9, 2024

(54) PRODUCT FOR MACHINE DISHWASHING IN THE FORM OF A CAPSULE WITH MULTIPLE COMPARTMENTS

(71) Applicant: Conopco Inc., d/b/a UNILEVER, Englewood Cliffs, NJ (US)

(72) Inventors: Amanda Jane Adams, Wageningen (NL); Robert John Carswell, Wageningen (NL); Graham Corlett, Wageningen (NL); Marina Mixtro Serrasqueiro, Wageningen (NL)

(73) Assignee: Conopco Inc., d/b/a UNILEVER, Englewood Cliffs, NJ (US)

(21) Appl. No.: 18/547,703

(22) PCT Filed: Mar. 10, 2022
(86) PCT No.: PCT/EP2022/056111

§ 371 Date: Aug. 24, 2023

(30) Foreign Application Priority Data
Mar. 26, 2021 (EP) 21165346.4

(51) Int. Cl. C11D 17/04; C11D 3/00; C11D 3/08; C11D 3/10; C11D 3/33; C11D 3/386; C11D 3/39

(52) U.S. Cl. CPC C11D 17/045; C11D 3/0005; C11D 3/08; C11D 3/10; C11D 3/33; C11D 3/38609; C11D 3/3932; C11D 2111/14

(57) ABSTRACT

The present invention relates to a product for machine dishwashing, comprising a capsule containing two or more compartments. The first compartment contains a solid, powdered first composition; and a second compartment contains liquid or gel second composition. The bleaching performance has been optimised, leading to better removal of tea stains. This has been achieved by an optimal combination of an alkali metal carbonate, a bleach component, sodium silicate and/or sodium disilicate, a bleach catalyst, and a maximum amount of tetraacetylethylenediamine.

### FIELD OF THE INVENTION

The present invention relates to a product for machine dishwashing, comprising a capsule containing two or more compartments, comprising a first compartment containing a solid, powdered first composition; and a second compartment containing a liquid or gel second composition. Moreover, the present invention relates to a method for preparation of the product for machine dishwashing and a method for cleaning bleachable stains, using the product for machine dishwashing.

### BACKGROUND TO THE INVENTION

Capsules containing multiple compartments for machine dishwashing are known in the art. Such capsules are typically made from water-soluble film, for example polyvinyl alcohol. The preferred capsule manufacturing process involves thermoforming the film. Thermoforming is a process in which a first sheet of film is subjected to a moulding process to form recesses in the film. The process involves heating the film to soften it, and then applying vacuum to hold the film in the moulds. The recesses are then filled. The capsules are completed by overlaying a second sheet over the filled recesses and sealing it to the first sheet of film around the edges of the recesses to form a flat sealing web.

Each compartment of a multi-compartment capsule may contain a different part of a cleaning composition. The compartments are connected to each other and separated from one another by at least one flat seal area. One compartment may contain a liquid part of the detergent composition and another compartment a granular or powdered part of the composition. Another of such detergent capsules shows a two compartment “stacked” capsule having a smaller liquid compartment and a larger powder compartment. Even another detergent capsule shows two thermoformed “capsules” to form a multi-compartment capsule whereby a first “capsule” having at least two smaller liquid compartments joined together with foldable flat seals is then used to seal a larger compartment.

Capsules with multiple compartments are suited for delivery of a detergent composition to dishwashing machine. Although a capsule with multiple compartments is more difficult to manufacture than a single compartment, it may be chosen because components of the detergent composition need to be mixed at point of use and/or have reduced stability when stored together. It may also give the capsule aesthetic appeal because the different compartments can be filled with different coloured contents. Nevertheless, in general the formulator would like to keep the number of compartments to a minimum in order to avoid complexity and added cost.

Non-pre-published patent application no. PCT/EP2020/071111 discloses a machine dishwasher capsule containing three compartments, each containing a composition; the first composition comprising a first liquid content, the second composition comprising a second liquid content, and the third composition comprising a powder content.

WO 2018/086834 A1 relates to multi-compartment water-soluble capsules made from water-soluble film, each compartment containing a part of a detergent composition, and additionally the manufacture of such capsules and associated manufacturing apparatus, as well as the use of such capsules. The three compartments each contain a liquid composition, preferably for use as laundry compositions.

EP 1 375 637 A1 relates to water soluble detergent sachets comprising a detergent composition, in particular a laundry detergent or machine dishwashing composition.

EP 2 857 486 A1 relates to a multi-compartment pouch comprising a selected combination of ingredients in different compartments as well as a washing process and the use of the multi-compartment pouch for laundry applications, such as for washing and cleaning of textiles, or for dishwashing applications.

WO 02/42408 A2 is in the field of dishwashing, in particular it relates to a water soluble multi-compartment pouch adapted to fit the dishwasher dispenser and to deliver product into the pre-wash, main wash and/or post-rinse cycles of the dishwashing machine.

EP 2 213 717 A1 relates to a laundry pouch made from a water-soluble film and having at least two compartments, containing a solid component and a liquid component, wherein the solid phase contains a peroxide source and a specific combination of polymers.

EP 3 050 953 A1 relates to a cleaning product, in particular to a phosphate-free automatic dishwashing detergent composition comprising a high level of a complexing agent and a low level of a polymer. The composition provides good cleaning, finishing, care and presents a good environmental profile.

WO 2014/011845 A1 relates to an automatic dishwashing composition having a preformed polymer with a zinc counterion and an amino acid based builder, which improves protection against aluminium corrosion.

DE 10 2018 212 086 A1 relates to dishwashing detergents containing the nonionic surfactant Ceteareth-9, having improved rinsing performance and storage stability.

EP 3 124 587 A1 relates to multi-compartment dishwashing pouches, containing both a compartment containing a powder and compartments containing liquids.

WO 2018/138124 A1 relates to a detergent composition for dishwashing, comprising a water-soluble pouch with at least two different compartments, one containing a powder and a second a liquid.

EP 3 760 699 A1 relates to a machine dishwashing composition that is able to provide effective cleaning, shine and care, with cleaning tea stains as an example.

US 2016/0222323 A1 relates to a method of automatic dishwashing using a a particulate loose-powder composition product comprising organic complexing agent, bleach, manganese bleach catalyst and free of phosphate.

US 2014/0018279 A1 relates to a method of cleaning dishware comprising the step of treating the dishware with a composition comprising an esterified benzene sulfonate, a peroxide source, and a non-ionic surfactant.

US 2005/0003982 A1 relates to a detergent pouch having walls comprised of a water-soluble water-containing polymer film, wherein the pouch has at least one compartment containing a liquid composition and at least one compartment containing a hygroscopic powder composition, wherein said liquid composition comprises from about 10 to 90% by weight thereof of a moisture regulator system.

### SUMMARY OF THE INVENTION

Objective of the present invention is to provide a capsule with two or more compartments, containing a composition suitable for machine dishwashing. The objective of such capsule is on the one hand improve the cleaning performance, and on the other hand to minimize the amount of compounds that will be used. Minimizing the amounts of compounds is essential, for cost reasons obviously, but also to minimize the amounts of compounds that are discharged to the sewer system, and potentially in the long term, into open waters. Therefore, the aim of the present invention is to use the compounds that are present in the composition as effectively and efficiently as possible. In particular, a purpose of the present invention is to provide compositions which have an optimised bleaching performance on coloured stains (such as tea and coffee stains).

This objective has been met by a product in a multi-compartment capsule, comprising a first compartment containing a powder with an optimised amount of alkali metal carbonate, bleach compound, manganese-based bleach catalyst, sodium silicate and/or sodium disilicate, and further containing a second compartment containing a liquid comprising a non-ionic surfactant and a builder compound. Therewith the use of tetraacetylethylenediamine (TAED) can be minimised, preferably can be absent. The amount of these compounds relative to each other has been optimised, and the compounds are used more efficiently. In spite of the absence of this well-known bleach activator, traditionally present in machine dishwash compositions, very good results are obtained on cleaning dishes with bleachable stains (in particular tea stains). The role between builder compounds (carbonate, silicates, builder compounds in the second composition), and bleach compound and bleach catalyst, and at the correct pH for optimum functionality, has been optimised. Therewith only a relatively small amount of first composition is required, and still very good bleaching performance is obtained.

Accordingly in a first aspect the invention provides a product for machine dishwashing, comprising a capsule containing two or more compartments, comprising
a first compartment containing a first composition;
a second compartment containing a second composition;
   wherein the first composition is a powdered composition, comprising, based on the weight of the first composition:
   an alkali metal carbonate, preferably sodium carbonate, at a concentration ranging from 25% to 60% by weight, preferably from 30% to 60% by weight;
   a bleach component, preferably sodium percarbonate, at a concentration ranging from 15% to 25% by weight;
   sodium silicate and/or sodium disilicate, at a concentration ranging from 4% to 10% by weight;
   a bleach catalyst, preferably a manganese-containing bleach catalyst, at a concentration ranging from 0.04% to 0.1% by weight;
   tetraacetylethylenediamine (TAED) at a concentration from 0 to maximally 0.1% by weight;
wherein the second composition is a liquid or a gel, comprising, based on the weight of the second composition:
   nonionic surfactant, at a concentration ranging from 1% to 10% by weight;
   one or more builder compounds, preferably selected from one or more aminocarboxylic acids, and wherein the concentration of builder compounds ranges from 15% to 25% by weight;
   and water.

Preferably the product of the invention consists of a capsule containing two or more compartments.

The first composition is a powdered composition, meaning that the composition is in the form of solid particles or granules combined into a powdered composition. Such a composition can on the scale of the compartment be considered to be homogeneous, although it may contain various granules with different compositions, e.g. a granule may contain a different amount of alkali metal carbonate than another granule. The overall composition of the first composition in the first compartment has the concentration of compounds provided above.

The second composition is a liquid or a gel, which means, in the context of the present invention, that a liquid is free-flowing, and a gel is generally not free-flowing on the time scale of one minute, but not solid either, and can easily be deformed with a relatively small force.

According to a second aspect, the invention provides a method for preparation of a product according to the first aspect of the invention, comprising the steps:
(i) placing a first sheet of water-soluble film over a mould comprising cavities;
(ii) heating and applying vacuum to the film to mould the film into the cavities and hold it in place to form corresponding recesses in the film;
(iii) filling a first recess with a first composition, wherein the first composition is a powdered composition, comprising, based on the weight of the first composition:
   an alkali metal carbonate, preferably sodium carbonate, at a concentration ranging from 25% to 60% by weight, preferably from 30% to 60% by weight;
   a bleach component, preferably sodium percarbonate, at a concentration ranging from 15% to 25% by weight;
   sodium silicate and/or sodium disilicate, at a concentration ranging from 4% to 10% by weight;
   a bleach catalyst, preferably a manganese-containing bleach catalyst, at a concentration ranging from 0.04% to 0.1% by weight;
   tetraacetylethylenediamine (TAED) at a concentration from 0 to maximally 0.1% by weight;
(iv) filling a second recess with a second composition, wherein the second composition is a liquid or a gel, comprising, based on the weight of the second composition:
   nonionic surfactant, at a concentration ranging from 1% to 10% by weight;
   one or more builder compounds, preferably selected from one or more aminocarboxylic acids, and wherein the concentration of builder compounds ranges from 15% to 25% by weight;
   and water;
(v) sealing a second sheet of film to the first sheet of film across the formed recesses to produce a capsule having at least two compartments separated from each other by a continuous internal sealing web.

According to a third aspect, the invention provides a method for cleaning bleachable stains, preferably tea and/or coffee stains, in a machine dishwashing process, using a product according to the first aspect of the invention.

### DETAILED DESCRIPTION OF THE INVENTION

The concentration of compounds is generally provided by weight percentage (wt %) as the amounts in the specific part of the composition, so by weight of the first composition, or the weight of the second composition, or by weight of any preferred further composition.

The first compartment contains a first composition, and the second compartment contains a second composition, both containing a multitude of ingredients.

The product of the invention is especially suitable for application in a machine dishwashing process because this process benefits highly from the option to include benefit agents for the rinse cycle in a second phase, which can be incorporated into the capsule. This means that the product includes one or more water soluble ingredients or components which aid in or enhance cleaning dishes. For example, the components forming the product may aid in better cleaning, cleaner appearance after rinsing, minimizing spot or film formation, etc. The product is formed of a multiple compounds, each compounds for aiding in one or more parts of a dishwashing cycle.

### Builder Compounds and Sequestrants

The term “builder compound” as used herein refers to a material that is capable of removing calcium and/or magnesium ion from aqueous solution by ion exchange, complexation, sequestration and/or precipitation.

Both the first composition and the second composition contain builder compounds. The first composition contains an alkali metal carbonate, preferably sodium carbonate. The second composition contains one or more builder compounds, preferably selected from one or more aminocarboxylic acids.

Preferably, the first composition further comprises an alkali metal citrate salt at a concentration ranging from 5% to 15% by weight of the first composition, preferably ranging from 6% to 14% by weight, more preferred from 8% to 12% by weight. The alkali metal citrate salt preferably comprises trisodium citrate dihydrate. In use the citrate will dissolve in water and may (partly) be present as an acid rather than a salt, depending on the pH of the wash or rinse liquor.

Also the second composition may comprise an alkali metal citrate salt or citric acid. If present, the concentration of the alkali metal citrate salt or citric acid preferably ranges from 5% to 15% by weight of the second composition, more preferred from 7% to 13% by weight. In the liquid or gel of the second composition, the alkali metal citrate salt will dissolve in the aqueous composition, and may be present as dissolved ions, with a single, double or triple negative charge, depending on the pH of the second composition.

The first composition comprises sodium silicate and/or sodium disilicate, at a concentration ranging from 4% to 10% by weight. Preferably the first composition comprises sodium silicate at a concentration ranging from 4% to 10% by weight. More preferred the first composition comprises hydrous sodium silicate at a concentration ranging from 4% to 10% by weight. The hydrous sodium silicate preferably has the molecular formula HNaO₃Si, and the mole ratio between SiO₂ and Na₂O preferably ranges from 2.6 to 2.7.

Preferably the concentration of sodium silicate and/or sodium disilicate in the first composition ranges from 4.5% to 8% by weight of the first composition, more preferred from 5% to 8% by weight, more preferred from 5% to 7% by weight. Preferably the concentration of hydrous sodium silicate and/or sodium disilicate in the first composition ranges from 4.5% to 8% by weight of the first composition., more preferred from 5% to 8% by weight, more preferred from 5% to 7% by weight.

Preferably, the first composition comprises both sodium silicate and sodium disilicate. The sodium disilicate preferably is a layered sodium disilicate, with the general molecular formula Na₂Si₂O₅. Preferably, the first composition comprises sodium silicate at a concentration ranging from 2.5% to 9.5% by weight, and sodium disilicate at a concentration ranging from 0.5% to 1.5% by weight of the first composition. More preferred, the concentration of sodium silicate ranges from 4% to 8% by weight, and sodium disilicate ranges from 0.5% to 1.5% by weight of the first composition. More preferred, the concentration of sodium silicate ranges from 4.5% to 7% by weight, more preferred from 4.5% to 6% by weight, and sodium disilicate ranges from 0.5% to 1% by weight.

Preferably, the first composition comprises hydrous sodium silicate at a concentration ranging from 2.5% to 9.5% by weight, and sodium disilicate at a concentration ranging from 0.5% to 1.5% by weight of the first composition. More preferred, the concentration of hydrous sodium silicate ranges from 4% to 8% by weight, and sodium disilicate ranges from 0.5% to 1.5% by weight of the first composition. More preferred, the concentration of hydrous sodium silicate ranges from 4.5% to 7% by weight, more preferred from 4.5% to 6% by weight, and sodium disilicate ranges from 0.5% to 1% by weight.

The silicates serve as builder compound, and additionally has other benefits. Such benefits include corrosion inhibitor for glass, and as a compound necessary to obtain the correct pH of the first composition.

The second composition contains one or more builder compounds, preferably selected from one or more aminocarboxylic acids, at a concentration of builder compounds ranging from 15 wt % to 25 wt % of the second composition. Preferably the aminocarboxylic acids are selected from tetrasodium salt of glutamic acid, N,N-diacetic acid (GLDA) and trisodium salt of methylglycinediacetic acid (MGDA). MGDA and GLDA are well-known builder compounds in machine dishwash compositions. A preferred source of GLDA is Dissolvine GL ex Nouryon (Arnhem, Netherlands), more in particular Dissolvine GL 47-S. The latter is a liquid form of GLDA with a concentration of about 47% GLDA-Na₄. A preferred source of MGDA is Trilon M ex BASF (Ludwigshafen, Germany), more in particular Trilon M Liquid. The latter is a liquid form of MGDA with a concentration of about 40% MGDA-Na₃.

Preferably the builder compounds are included at a concentration ranging from 16% to 24% by weight of the second composition, more preferred from 17% to 23% by weight. Preferably the builder compounds tetrasodium salt of glutamic acid, N,N-diacetic acid (GLDA) and trisodium salt of methylglycinediacetic acid (MGDA), are included at a concentration ranging from 16% to 24% by weight of the second composition, more preferred from 17% to 23% by weight.

Preferably, the first composition is free from builder compounds, selected from one or more aminocarboxylic acids, more preferred free from GLDA and MGDA.

Preferably, in the first composition the weight ratio between alkali metal carbonate on the one hand and sodium silicate and/or sodium disilicate on the other hand ranges from 2.5 to 12, preferably from 4 to 11. More preferred the ratio ranges from 5 to 10, more preferred from 6 to 10. Within this ratio, the cleaning performance of a product of the invention, in particular the bleach performance, is optimal.

Builder compounds or sequestrant material used in the present invention is preferably fully soluble so as to eliminate the possibility of unwanted and unsightly residues on substrates. For that reason alkali metal aluminosilicates are not favoured, and preferably absent from the product of the invention.

The product of the invention is preferably free from inorganic builder compounds based on phosphates. This includes the water-soluble salts of phosphates, especially alkali metal pyrophosphates, orthophosphates and polyphosphates. Examples of inorganic phosphate builder compounds which are preferably absent from the product include sodium and potassium tripolyphosphates, pyrophosphates and hexametaphosphates.

Nevertheless, either of the first composition and the second composition or both may contain a phosphonate. In case phosphonate is present, then preferably 1-hydroxyl ethylidene-1,1-diphosphonic acid (HEDP) is present. Preferably, in case HEDP is present, then preferably the maximum concentration of HEDP in the first composition is less than 1.0% by weight, more preferably less than 0.8% by weight of the first composition. Preferably, in case HEDP is present, then preferably the maximum concentration of HEDP in the second composition is less than 0.6% by weight, more preferably less than 0.5% by weight of the second composition.

Other non-phosphorus water-soluble builder compounds may be present, such as alkali metal carbonates other than sodium carbonate, bicarbonates, sesquicarbonates, borates, and crystalline and amorphous aluminosilicates, and organic builders as polycarboxylate polymers, such as polyacrylates, acrylic/maleic copolymers, and acrylic phosphonates, monomeric polycarboxylates such as citrates other than sodium citrate, gluconates, oxydisuccinates, glycerol mono—di and trisuccinates, carboxymethyloxysuccinates, carboxymethyloxymalonates, dipicolinates and hydroxyethyliminodiacetates.

More preferred though, the product of the invention does not comprise other builder compounds in addition to the alkali metal carbonate, and the sodium silicate and/or sodium disilicate in the first composition, and the builder compound, preferably selected from one or more aminocarboxylic acids in the second composition, and the preferred alkali metal citrate salt in the first composition.

### Polymers

The first and the second composition each may contain one or more polymers. In the context of the present invention, these polymers are not considered to be builder compounds, although they may incidentally bind calcium or magnesium in the wash liquor. Such polymers may be used to improve drying of dishes, to prevent spotting and stripes on the dishes, and may have other benefits as well.

Polymers may be comprised in both the first composition, and the second composition.

Preferably the first composition comprises maximally 10% by weight of polymers, preferably maximally 8% by weight, preferably maximally 6% by weight. If present, then preferably the concentration of polymers ranges from 2% to 10% by weight, preferably from 3% to 8% by weight, preferably from 3% to 6% by weight.

Preferably the second composition comprises maximally 10% by weight of polymers, preferably maximally 9% by weight, preferably maximally 8% by weight. If present, then preferably the concentration of polymers ranges from 3% to 10% by weight, preferably from 4% to 8% by weight, preferably from 4% to 7% by weight.

Preferred polymers for the first composition, as well as for the second composition include polyacrylate homopolymers, such as Sokalan PA15 or Sokalan PA25 (ex BASF), which are polyacrylic acids; polyacrylate co-polymers, such as Sokalan CP5 (ex BASF), which is a maleic acid-acrylic acid copolymer; and/or sulphonated co-polymers, such as Sokalan CP50 (ex BASF), a sulphonated co-polymer of 2-Acrylamido-2-methyl-1-propansulfonsaure (AMPS) and acrylic acid; or such as Acusol 588 (ex Dow), a co-polymer of AMPS and acrylic acid; or amphoteric polymers, such as Mirapol Surf S (ex Solvay).

Another preferred polymer for the second composition includes xanthan gum, for example Rhodopol G (ex Solvay).

### Bleaching Compounds

The term “bleach component” as used herein refers to substances that are capable of removing coloured stains by oxidizing or reducing the colour components of the stain. The first composition comprises a bleach component at a concentration ranging from 15% to 25% by weight of the first composition.

The bleach component employed in the present detergent composition preferably is an oxidizing bleach component. The oxidizing bleach component may suitably comprise a chlorine-, or bromine-releasing agent or a peroxygen compound. Preferably, the bleach component is selected from peroxides (including peroxide salts such as sodium percarbonate), organic peracids, salts of organic peracids and combinations thereof. More preferably, the bleach component is a peroxide. Examples of peroxides are acids and corresponding salts of monopersulphate, perborate monohydrate, perborate tetrahydrate, and percarbonate. More preferably, the bleach component is a percarbonate, most preferably sodium percarbonate.

Organic peracids useful herein include alkyl peroxy acids and aryl peroxyacids such as peroxybenzoic acid and ring substituted peroxybenzoic acids (e.g. peroxy-alpha-naphthoic acid), aliphatic and substituted aliphatic monoperoxy acids (e.g. peroxylauric acid and peroxystearic acid), and phthaloyl amido peroxy caproic acid (PAP).

Preferably the concentration of the bleach component in the first composition ranges from 15% to 22% by weight, preferably from 15% to 20% by weight, more preferably from 16% to 19% by weight of the first composition. Similarly, for the preferred bleach component sodium percarbonate, the concentration in the first composition ranges from 15% to 22% by weight, preferably from 15% to 20% by weight, more preferably from 16% to 19% by weight of the first composition.

The term “bleach activator” as used herein refers to compounds employed in cleaning compositions to activate the bleaching agent, or bleach component, especially at lower temperatures.

Examples of bleach activators suitable for use in the cleaning compositions of this invention include one or more activators such as peroxyacid bleach precursors. Peroxyacid bleach precursors are well known in the art. As non-limiting examples can be named tetraacetylethylenediamine (TAED), sodium nonanoyloxybenzene sulphonate (SNOBS), sodium benzoyloxybenzene sulphonate (SBOBS) and the cationic peroxyacid precursor (SPCC). In case a bleach activator is present, then it may suitably be present in the composition in the form of a encapsulate, notably an encapsulate that is separate from the bleach particles in order to avoid premature bleach activation.

The first composition may contain tetraacetylethylenediamine (TAED), at a concentration of maximally 0.1% by weight. The concentration of TAED in the first composition ranges from 0 to maximally 0.1% by weight. Preferably the concentration of TAED is maximally 0.05% by weight of the first composition. More preferred the first composition is free from tetraacetylethylenediamine (TAED). Preferably also the second composition is free from TAED. More preferred the entire composition is free from TAED. Most generally, the teaching of many prior art documents is that a machine dishwash composition contains TAED at a concentration ranging from 0.1 to 10% by weight of the composition. Nevertheless, in spite of the absence of TAED, the product of the invention provides very good results on cleaning of tea stains.

Preferably, other bleach activators, like peroxyacid bleach precursors, are also absent from the entire composition. Preferably, the composition is free from sodium nonanoyloxybenzene sulphonate (SNOBS), sodium benzoyloxybenzene sulphonate (SBOBS) and the cationic peroxyacid precursor (SPCC).

A “bleach catalyst” is a compound that also activates the bleaching process. Bleaching catalysts are also known in the art. The first composition of the invention comprises a bleach catalyst at a concentration ranging from 0.04% to 0.1% by weight of the first composition. Such bleach catalyst preferably comprises a manganese-containing bleach catalyst, preferably at a concentration ranging from 0.04% to 0.1% by weight of the first composition. Preferably the concentration of the bleach catalyst in the first composition ranges from 0.04% to 0.09% by weight, more preferred from 0.05% to 0.08% by weight of the first composition.

Preferred manganese-containing bleach catalysts include a manganese complex as described in EP 0 458 397 A2. Preferably the first composition comprises a complex of formula (A):

[LₙMnₘXₚ]^{z}Y_{q};

wherein Mn is manganese, which can be in the II, III, IV or V oxidation state, or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula:

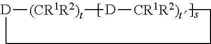

wherein R 1 and R 2 can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5.

Preferred ligands are 1,4,7-trimethyl-1,4,7-triazacyclononane (coded as Me-TACN); 1,4,7-triazacyclononane (coded as TACN); 1,5,9-trimethyl-1,5,9-triazacyclododecane (coded as Me-TACO); 2-methyl-1,4,7-trimethyl-1,4,7-triazacyclononane (coded as Me/Me-TACN); and 2-methyl-1,4,7-triazacyclononane (coded as Me/TACN). Ligands Me-TACN and Me/Me-TACN are particularly preferred for use as bleach catalyst.

Preferably the first composition comprises Me-TACN at a concentration ranging from 0.04% to 0.1% by weight of the first composition, preferably 0.04% to 0.09% by weight, more preferred from 0.05% to 0.08% by weight.

Preferably the first composition comprises Me/Me-TACN at a concentration ranging from 0.04% to 0.1% by weight of the first composition, preferably 0.04% to 0.09% by weight, more preferred from 0.05% to 0.08% by weight.

Preferably the first composition comprises a combination of Me-TACN and Me/Me-TACN at a concentration ranging from 0.04% to 0.1% by weight of the first composition, preferably 0.04% to 0.09% by weight, more preferred from 0.05% to 0.08% by weight.

### Surfactants

The second composition of the product of the invention comprises a nonionic surfactant. The nonionic surfactant preferably is a low-foaming nonionic surfactant. A preferred nonionic surfactant for use in the second composition is a modified fatty alcohol polyglycol ether, such as Dehypon E127 (ex BASF, Ludwigshafen, Germany). Other useful nonionic surfactants include for example Dehypon WET (ex BASF), Lutensol AT80 (ex BASF), Ecosurf Bright 12 (ex Dow), and Genapol EC50 M90 (ex Clariant). The concentration of the nonionic surfactant in the second composition ranges from 1% to 10% by weight of the second composition. Preferably the concentration ranges from 1% to 5%, more preferred from 1% to 3% by weight.

Preferably the first composition also comprises a nonionic surfactant. The type of nonionic surfactant may be the same as for the second composition. The nonionic surfactant preferably is a low-foaming nonionic surfactant. Preferred nonionic surfactants for use in the first composition are modified fatty alcohol polyglycol ether, such as Dehypon E127 (ex BASF, Ludwigshafen, Germany). Other preferred nonionic surfactants include for example Dehypon WET (ex BASF), Lutensol AT80 (ex BASF), Ecosurf Bright 12 (ex Dow), and Genapol EC50 M90 (ex Clariant). The concentration of the nonionic surfactant in the first composition preferably ranges from 0.5% to 5% by weight of the first composition, preferably from 1% to 4%, more preferred from 1% to 3% by weight.

### Other Compounds

The first composition of the invention preferably comprises one or more enzymes; preferably selected from proteases and/or amylases. Such enzymes are commonly known to be used in machine dishwash compositions. The enzymes may be immobilised on a carrier, or in a liquid.

Optional ingredients are, for example, buffering agents, reducing agents, e. g., borates, alkali metal hydroxide and the well-known enzyme stabilisers such as the polyalcohols, e. g. glycerol and borax; crystal-growth inhibitors, threshold agents; perfumes and dyestuffs and the like.

Glass corrosion inhibitors can prevent the irreversible corrosion and iridescence of glass surfaces in automatic dishwash detergents. The claimed composition may suitably contain glass corrosion inhibitors. Suitable glass corrosion inhibitors can be selected from the group the group consisting of salts of zinc, bismuth, aluminum, tin, magnesium, calcium, strontium, titanium, zirconium, manganese, lanthanum, mixtures thereof and precursors thereof. More preferred are salts of bismuth, magnesium or zinc or combinations thereof. The most preferred glass corrosion inhibitors are silicate, disilicate or combinations thereof. Using silicates helps on reducing the glass corrosion as well as aluminium corrosion over time.

Anti-tarnishing agents may prevent or reduce the tarnishing, corrosion or oxidation of metals such as silver, copper, aluminium and stainless steel. Anti-tarnishing agents such as benzotriazole, methyl benzotriazole or bis-benzotriazole and substituted or substituted derivatives thereof and those described in EP 0 723 577 may also be included in the composition.

The second composition may comprise monoethanolamine, if present preferably at a concentration ranging from 4% to 8% by weight of the second composition, preferably ranging from 5% to 7% by weight.

Preferably the composition of the invention is free from a preformed polymer with a zinc counterion. As used herein, the term ‘preformed’ refers to a separate entity of polymer and zinc counterion that is created before its subsequent addition to the rest of the composition.

Most preferred the invention provides a product for machine dishwashing, comprising a capsule containing two or more compartments, comprising
a first compartment containing a first composition;
a second compartment containing a second composition;
   wherein the first composition is a powdered composition, comprising, based on the weight of the first composition:
   sodium carbonate, at a concentration ranging from 25% to 60% by weight;
   sodium percarbonate, at a concentration ranging from 15% to 25% by weight;
   sodium silicate and/or sodium disilicate, at a concentration ranging from 4% to 10% by weight;
   a manganese-containing bleach catalyst, at a concentration ranging from 0.04% to 0.1% by weight;
wherein the second composition is a liquid or a gel, comprising, based on the weight of the second composition:
   nonionic surfactant at a concentration ranging from 1% to 10% by weight;
   one or more builder compounds, preferably selected from one or more aminocarboxylic acids, and wherein the concentration of builder compounds ranges from 15% to 25% by weight;
   and water, and wherein the first composition is free from tetraacetylethylenediamine (TAED). Most preferred the builder compounds are selected from tetrasodium salt of glutamic acid, N,N-diacetic acid (GLDA) and trisodium salt of methylglycinediacetic acid (MGDA); and water.

### Capsule

In a first aspect the invention provides a product for machine dishwashing, comprising a capsule containing two or more compartments. The capsule can also be considered to be a pouch, which is known in the art. Examples of such pouches are available from various brands and manufacturers.

In the context of the invention the terms “wrap” and “film” are used interchangeably. In an embodiment, the entire capsule may be coated or wrapped in a film. The film can be water-soluble film. It is highly preferred that the film is at least partly transparent such that the contents can be seen. This way the consumer does not miss out on the visible cue provided by the first, and second contents of the capsule. Preferably the entire film is transparent. Optionally there are prints on the film, e.g. pictures, letters and/or words.

The film preferably is a flexible film, contrary to solid, self standing containers. The flexible film preferably surrounds the capsule such that there is little room for any movement of or between compartments.

It will be appreciated that the volume of the film should be such that it does not interfere with placing it in the dispenser of a dishwashing machine or in a container or packaging.

The film can be made of a water-soluble film material or at least partially water soluble film material. Water-soluble material has the advantage that the multi-component tablet can be directly applied in the washing. The desired degree of solubilisation and strength can be achieved by matching the type of material and its thickness such that the desired solubilisation time is achieved while still maintaining the desired strength. Also, preferably, the film material is deformable under heating conditions.

Water soluble materials which may be used to form the water soluble films include polyester amides, polyvinyl alcohol, copolymers of vinyl alcohol and methacrylate, polyethylene oxide, alginates, cellulose ethers such as carboxymethyl cellulose and methylcellulose, starches and starch derivatives, gelatin and any combination of these. The film is preferably polyvinyl alcohol film and it is more preferably less than 100 micron thick in the finished capsule.

The product of the invention comprises a capsule containing two or more compartments, preferably consists of a capsule containing two or more compartments. Preferably, the first compartment and the second compartment are separated from each other in a sealing plane.

Another aspect of the invention provides that each of the first compartment and the second compartment extend at maximum a first distance below the sealing plane. Additionally, the first compartment and the second compartment extend at maximum a second distance above the sealing plane. Optionally, the first distance and the second distance are substantially equal.

Another aspect of the invention provides a first compartment and a second compartment arranged in a non-overlapping arrangement with respect to a sealing plane. Another aspect of the invention provides a first compartment and a second compartment configured to stack with an adjacent capsule of the same configuration.

The capsules according to the invention are suitable for use in a machine dishwashing process, as this process benefits highly from the option to include benefit agents for washing and rinse cycles in separated compartments.

### Thermoforming Process

The product of the invention comprising the capsule, preferably consisting of a capsule, is preferably produced by a process of thermoforming. Such a process preferably comprises the following steps to form a capsule:

First, placing a first sheet of a water-soluble film, preferably a polyvinyl alcohol film, over a mould comprising cavities.

Second, heating and applying vacuum to the film to mould the film into the cavities and hold it in place to form corresponding recesses in the film.

Third, filling the different parts of a detergent composition, each of which may have a different colour/opacity (as well as different treatment function) into the recesses, the parts together forming a full detergent composition. The powdered first composition is preferably filled into the first compartment before the liquid second composition is filled into the second compartment. This has the advantage that any spilled solid material can be removed from the liquid compartment and seal areas before the liquid compartment is filled.

Fourth, sealing a second sheet of film to the first sheet of film across the formed recesses to produce a capsule having three compartments separated from each other by a continuous internal sealing web. Sealing can be done by any suitable method, for example heat-sealing, solvent sealing or UV sealing, ultrasound or a combination of any (e.g., two) of these. Particularly preferred is water-sealing. Water sealing may be carried out by applying moisture to the second sheet of film before it is sealed to the first sheet of film to form the seal area.

Fifth, cutting between the capsules so that a series of capsules with two or more compartments are formed, each capsule containing a part of a detergent composition in two or more compartments (e.g., one larger-sized compartment and one or more relatively medium-sized compartments).

Preferably, the product of the invention comprises a capsule containing three compartments, wherein the third compartment contains a third composition; and wherein the first and the second and the third compartment are separated from each other in a sealing plane. More preferred, the product of the invention consists of a capsule containing three compartments, wherein the third compartment contains a third composition; and wherein the first and the second and the third compartment are separated from each other in a sealing plane.

Preferably, the first compartment has a generally semi-circular shape in plan view, wherein a straight line portion of the semi-circular compartment is located on a side of the capsule and extends between two adjacent corners of the capsule. Generally semi-circular means that the plan view of the shape is a half or part of a circle. This is achieved by use of a semi-circular mould cross-section for the compartment. The relaxation of the formed capsule once it has been removed from the mould can change the compartment, for example, change a semi-ovaloid cross-section to be nearer to a fully ovaloid cross-section. In any event the cross-section remains substantially uniform because the relaxation is substantially uniform.

In a preferred embodiment of the product of the invention containing three compartments, at least one compartment, is generally triangular in plan view, and is located at a corner of the capsule. In some instances, the compartment can span to two or three corners of the capsule if the capsule is square or rectangular. Generally triangular means that the plan view of the shape is triangular in shape, but can, for example, have rounded corners. Alternatively, the second compartment and/or the third compartment can be generally polygonal in plan view. These shapes are achieved by use of various mould cross-sections for each compartment.

The sealing area between the first compartment and the second compartment, the second compartment and the third compartment, and the first compartment and the third compartment has a width sufficient to ensure sealing between the compartments, for example, from 0.1 to 3 mm, preferably from 0.1 to 2 mm.

Each of a preferred first compartment, second compartment and third compartment are separated from each other in a sealing plane. This sealing plane is typically at a centre of the cross-section of each of the compartments (i.e., they extend above and below the sealing plane a substantially equal distance), though could be off-centre in some embodiments (e.g., the maximum distance above the sealing is larger than the maximum distance below the sealing plane). This could be achieved with, for example, different moulds and/or use of different strength films on the top versus the bottom.

Preferably, each of a preferred first compartment, a second compartment and a third compartment extends at a maximum first, second and third distance above the sealing plane, respectively. Each of the first compartment, the second compartment and the third compartment extends at a respective maximum fourth distance below the sealing plane. Preferably the first distance is greater than the second distance and the third distance. In another embodiment, the second distance and the third distance may be substantially equal.

For example, in the case of embodiments in which the capsule has a polygonal shape with straight sides meeting at vertices, then the maximum height corresponds to the distance between opposing vertices of the polygon. Linear dimensions of width and height are measured as linear dimensions. Thus, the width is the linear measurement in the x direction (along the x axis) using a top plan view of the unit dose, including any outer sealing web. The length is a linear measurement in the y direction (along y axis) using a top plan view of the capsule, including any outer sealing web.

In a preferred embodiment of such capsule with three compartments, a first capsule is stackable with a second capsule, the second capsule being adjacent the first capsule. The first compartment, the second compartment and the third compartment of the first capsule are configured to stack with the adjacent second capsule of the same configuration. This can be through a number of different configurations, for example, through the arrangement of the compartments with respect to each other and/or sealing lines forming a configuration which allow for efficient use of space when stacking. Another configuration could use different maximum distances extending above the sealing plane allowing the compartments to fit together complementary to each other, e.g., the first, the second and the third compartment of the first capsule end in a position of the capsule forming a sort of natural cavity into which a bulge of the largest compartment of the adjacent second capsule fits. The configuration could be for stacking in the same orientation, stacking as pairs and/or staggered, with a first capsule in a first orientation and a second capsule in a second orientation to fit together for efficient use of space when stacking.

An unexpected advantage of this capsule shape has been the way that it seems to automatically take up less volume in a pack due to the shape helping it to form staggered stacks of capsules with minimal wasted space in between. This is achieved by the configuration of the capsule, examples of which are described above. Further embodiments varying the configuration, shape and size of the capsule compartments to form capsules with naturally stacking shapes can be envisaged. In some embodiments, it would even be possible to dispense the capsules from a tube-like pack containing a highly efficiently packed single stack of capsules by maximizing the number of capsules required to full a pack containing and further lowering shipping cost. It would also be possible to improve stability during transport even in a flexible plastic container.

In a preferred embodiment of the product of the invention containing three compartments, the third compartment contains a third composition. The third composition may be a powdered composition or may be a liquid or a gel. The third composition may have a different composition than the first composition and the second composition. Alternatively, the third composition may have the same composition as the first composition, although in such case a dye may be added to the third composition to give the third composition a different colour than the first composition has. Such product will be attractive to consumers. Alternatively, the third composition may have the same composition as the second composition, although in such case a dye may be added to the second composition to give the third composition a different colour than the second composition. Preferably the second composition is similar to the third composition, with the only difference being the presence of dyes that give the second and third compositions different colours. In general, consumers like a product of the invention, in case the compositions in the compartments have different appearances, like different colours.

Therefore, preferably the product of the invention contains at least two compositions in two compartments, with two different colours. Preferably the product of the invention contains at least three compositions in three compartments, with at least 2 different colours, preferably at least 3 different colours.

The first and the second compartment of the product of the invention may have equal volumes, or more preferred, they have a different volume. More preferred the first compartment has a larger volume than the second compartment. In a preferred embodiment of the product of the invention containing three compartments, the first compartment is larger than each of the second and third compartments. Preferably, the second and the third compartment have the same volume.

Preferably each compartment has a maximum depth of from 5 to 40 mm, more preferred from 8 to 30 mm, most preferred from 9 to 20 mm. Preferably the height (h) of the capsule ranges from 5 to 40 mm, more preferable 8 to 30 mm, and most preferable 9 to 20 mm. Preferably both the width (w) and the length (I) of the capsule are more than 20 mm, more preferable more than 25 mm. Preferably the maximum linear dimension is 50 mm, preferably maximally 40 mm, preferably maximally 30 mm. In a preferred embodiment the length is 40 mm and the width is 30 mm.

Preferably, in a product comprising a capsule the weight of the first composition in the first compartment ranges from 8 to 13 gram, preferably from 8 to 12 gram. Preferably the weight of the first compartment ranges from 10 to 12 gram. Preferably, the weight of the second composition in the second compartment ranges from 1.5 to 10 gram, preferably from 2 to 8 gram, preferably from 3 to 6 gram. Preferably, the weight of the third composition in the third compartment ranges from 1.5 to 8 gram, preferably from 1.5 to 6 gram, preferably from 1.5 to 4 gram. If the weight of the compositions is within these ranges, good cleaning results are obtained.

### DESCRIPTION OF PREFERRED PRODUCT OF THE INVENTION

The invention will now be further described with reference to the following preferred product in the form of a capsule containing three compartments, with reference to the drawings. More preferred, the product of the invention consists of a such capsule containing three compartments.

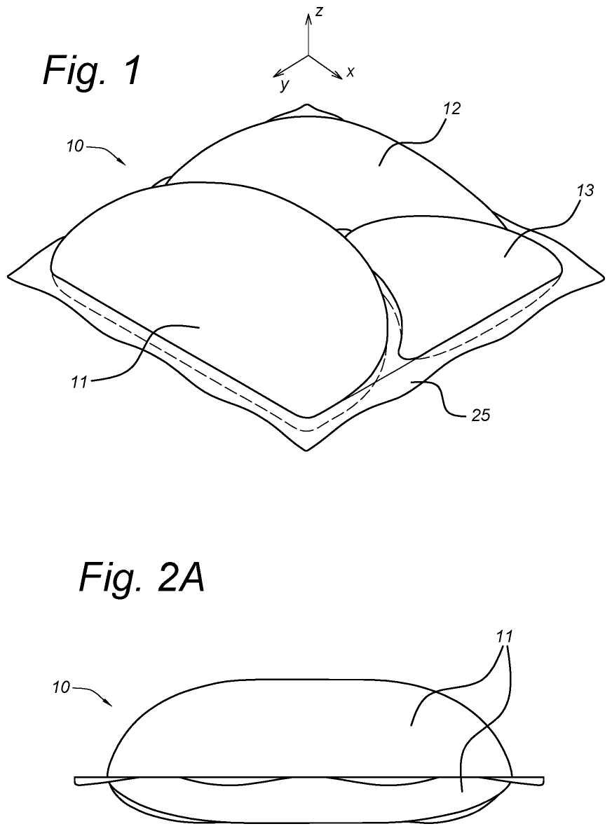

FIG. 1 is a plan view of a capsule with three compartments according to a preferred embodiment of the present invention;

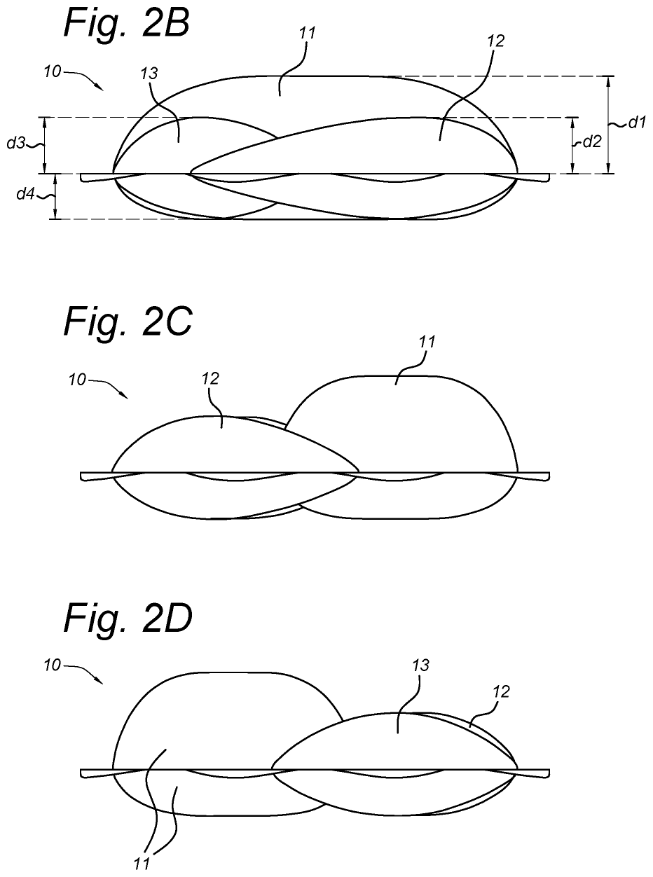

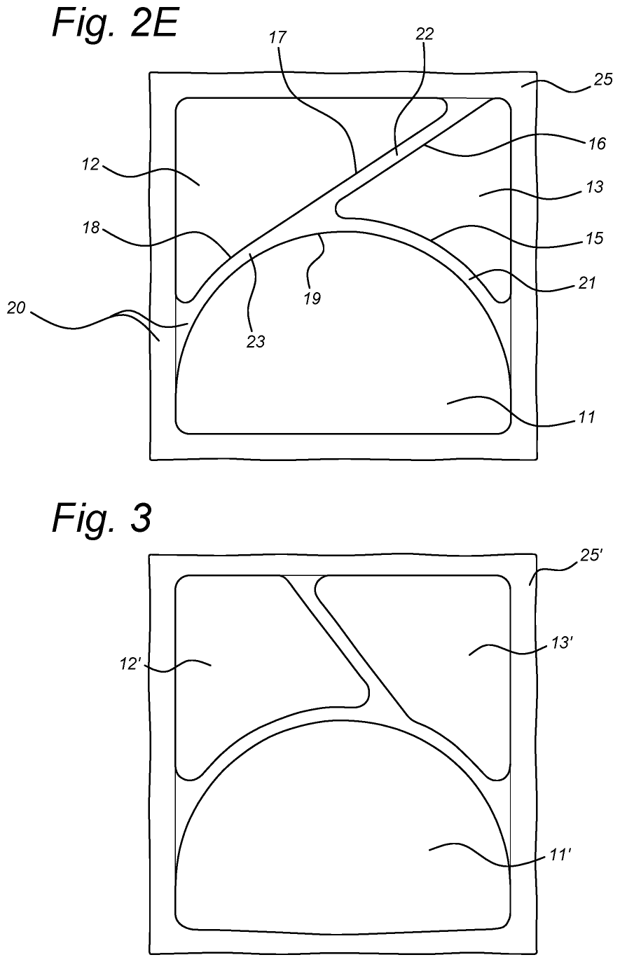

FIG. 2A shows a plan view of the preferred capsule;

FIG. 2B shows a front view of the preferred capsule;

FIG. 2C shows a back side view of a preferred capsule;

FIG. 2D shows a left side view of a preferred capsule;

FIG. 2E shows a right view of a preferred capsule; and

FIG. 3 is a top view of a preferred capsule with three compartments according to another preferred embodiment.

Coordinate axes in the x, y and z direction are shown in each figure to assist in the explanation of the relative arrangement of features of the capsule. FIG. 1 and FIGS. 2A-2E are discussed here to aid understanding of the subsequent discussion of the shape and configuration of the preferred capsule with three compartments.

FIG. 1 shows a perspective view of a preferred capsule 10 according to the current invention. The capsule 10 includes a first compartment 11, a second compartment 12 and a third compartment 13. Each of the compartments 11, 12, 13 defines a tight and hermetically sealed chamber containing a part of a detergent composition. The compartments are arranged adjacent one another, as will be described in more detail in relation to FIGS. 2A-2E.

FIG. 2A shows a back side view of capsule 10, FIG. 2B shows a front view of the capsule 10; FIG. 2C shows a left side view of the capsule 10; FIG. 2D shows a right side view of the capsule 10; and FIG. 2E shows a plan view of the capsule 10.

Each compartment 11, 12, 13 of the capsule 10 is defined between the upper and lower layers of a water-soluble film, and is sealed around its respective periphery by the sealing of the two layers of film around. The upper and lower film layers are also sealed together around the three compartments to form a sealing perimeter 25 extending around all of the compartments 11, 12, 13. In capsule 10, this sealing perimeter 25 forms a square outer edge. Alternatively, other forms may equally be applied for example various shapes composed of curved or straight lines or combinations thereof for example triangle, rectangle, hexagonal, round, square or elliptical to form the sealing perimeter.

The sealing web 20 is formed from fusing, e.g. thermoforming, a first and second sheet of water-soluble film during manufacture of the capsule. The sealing web 20 comprises the sealing perimeter 25 that lies in the x-y plane and is referred to herein as the sealing plane. The linear dimensions of the sealing perimeter 25 define the width and the length of the capsule 10. Additionally, the sealing web 20 also comprises three internal sealing webs 21, 22, 23. These are also in the sealing plane and extend across the capsule so as to define the inside-facing side edges 15, 16 of the third compartment 13, the inside-facing side edges 17, 18 of the second compartment 12 and the inside-facing side edge 19 of the first compartment 11. Thus the third compartment 13 and the first compartment 11 are connected to each other, with the internal chambers separated from one another by the first internal sealing web 21; the second compartment 12 and the third compartment 13 are connected to each other, with the internal chambers separated from one another by the second internal sealing web 22; and the first compartment 11 and the second compartment 12 are connected to each other, with the internal chambers separated from one another by the third internal sealing web 23. The internal sealing webs 21, 22, 23 typically separate one compartment from one another by a minimum linear distance defined in the sealing plane of 3 mm or less, preferable 2 mm or less. This can be more or less in some cases depending on the fill of the capsule, components used in the capsule, intended use, etc.

Preferably, the maximum linear dimension of the length is 45 mm and the width is 40 mm. Other embodiments could have a linear dimension of length and width of suitably ≥20 mm, ≥30 mm. In some embodiments the maximum linear dimension is ≤50 mm, suitably ≤40 mm, ≤30 mm. In some embodiments, the length and width of the capsule 10 would not be the same, resulting in a rectangular capsule (plan view).

In the preferred embodiment shown, each of the three compartments 11, 12, 13 are arranged in a non-overlapping arrangement with respect to the sealing plane, so that it is possible to form the sealing web using only two sheets of water-soluble film. This leads to a low complexity and reduced production cost of the capsule.

In the preferred embodiment shown, the first compartment 11 is generally semi-circular in the sealing plane, and is located in a side of the capsule 10 of which the outside-facing side edge extends between two adjacent corners of the capsule 10.

In the preferred embodiment shown, the at least one of the third compartment 13 and the second compartment 12 are each generally triangular in plan view, and are each located in proximity to at least a corner of the capsule 10. In other embodiments, as shown in FIG. 3, the third compartment 13′ and/or the second compartment 12′ could be generally polygonal in the sealing plane, preferable a generally four-side polygon.

The second compartment 12 has two outside-facing side edges, located on both sides of one corner of the capsule 10, and one inside-facing side edge that extends in a first portion generally parallel to the semi-circular side edge of the first compartment 11 and in a second portion generally parallel to one inside-facing side edge of the third compartment 13. The third compartment 13 has one outside-facing side edge, extending between two adjacent corners of the capsule 10, and two inside-facing side edges, one inside-facing side edge extending generally parallel to the semi-circular side edge of the first compartment 11, and the other inside-facing side edge extending generally parallel to the inside-facing side edge of the second compartment 12.

Reference herein to depth of a feature, or to a feature being, or extending, “above” or “below” is a reference to the dimension (direction, axis) in the z direction, i.e. perpendicular to the sealing plane (x-y plane). Naturally, the terms “above”, “below”, “up”, “down”, etc. are relative not absolute terms and they are used accordingly herein, and to aid understanding.

Each of the first compartment 11, the second compartment 12, and the third compartment 13 extends above the sealing plane such that the part of each compartment that is furthermost from the sealing plane, in a direction perpendicular to the sealing plane is referred to herein as the first distance (d1), the second distance (d2), and the third distance (d3), respectively; wherein d1 is ≤40 mm, ≤30 mm, ≤20 mm, or ≤12 mm; d2 is ≤20 mm, ≤12 mm, or ≤8 mm; and d3 is ≤20 mm, ≤12 mm, or ≤8 mm.

Each of the three compartments 11, 12, 13 extends below the sealing plane such that the part of each compartment that is furthermost from the sealing plane, in a direction perpendicular to the sealing plane is referred to herein as the fourth distance (d4), wherein d4 ranges from 5 to 9 mm.

In the embodiment shown, the first distance (d1) is greater than the third distance (d3) and the second distance (d2). Further, the first distance (d1) is greater than the fourth distance (d4). The third distance (d3) is substantially equal to the second distance (d2). The third distance (d3) and the second distance (d2) could differ in some embodiments. The second distance (d2) and the fourth distance (d4) are substantially equal. In other embodiments, the second distance (d2) could be longer than the fourth distance (d4). Further the maximum distance below the sealing plane could differ between compartments in some embodiments.

Each of the compartments 11, 12, 13 of the preferred capsule 10 contains a part of the product for machine dishwashing of the invention. In the current invention, the first compartment 11 contains a first composition 31, the second compartment 12 contains a second composition 32, and the third compartment 13 contains a third composition 33. The first composition 31 is a powdered content, the second composition 32 is a liquid or gel content and the third composition 33 is a powdered or liquid or gel content.

Hereinafter, the first volume (V1) denotes the volume which can be held in the first compartment 11, the second volume (V2) denotes the volume which can be held in the second compartment 12, and the third volume (V3) denotes the volume which can be held in the third compartment 13.

In the embodiment shown in FIGS. 1-2E, the first compartment 11 is configured to hold a larger volume (V1) of composition than each of the second and third compartments 12, 13. The second compartment 12 is configured to hold a larger volume (V2) of composition than the third compartment 13, V1>V2>V3. Other embodiments could have the second and third compartments holding a substantially equal volume, V1>V2=V3, as shown in FIG. 3. Since in machine dishwashing the amounts used of each ingredient can be different, this configuration can improve the distribution or segregation of the ingredients of the compositions in different compartments, by filling them with different and varied ingredients. In the case two compartments contain a liquid, and these compartments have relatively the same volume or liquid dosage, the manufacture process of the capsule can be more efficient. By having the liquid compartments relatively the same volume and next to each other, gives the capsule more flexibility and durability than if they were separated by the powder compartment.

The volume of the first compartment 11 is such that the weight of the powdered composition is at least 8 gram, preferably 10 gram. In case both compartments 12 and 13 contain a liquid compound, then the weight of these is each substantially at least 1.5 gram. By having the liquid compound a weight above approximately 2 gram, the compartments containing the liquid compounds can contain a variety of ingredients, such as a surfactant, a builder and a polymer.

By forming capsule 10 with first, second and third compartments 11, 12, 13 separated by a sealing plane; capsule 10 is able to deliver three different components to a washing operation in a compact and reliable form. The use of a sealing plane provides for a stable separation of the interior of compartments and results in a flexible capsule that takes up less volume in a package. The compartments 11, 12, 13 are efficiently shaped to ensure proper amounts of components are able to be stored and delivered while minimized the overall size of capsule 10. Providing capsule 10 with three compartments 11, 12, 13 allowing for the use of three different components can result in a more targeted and/or effective cleaning operation than past capsules or tablets that only included one or two components. For example, three separate components targeting a specific situation, e.g., heavy use pots and pans, could be included in capsule 10 making it more effective toward its targeted substrate.

In another embodiment, the capsule 10 is stackable with an adjacent capsule. The first compartment 11, the second compartment 12 and the third compartment 13 of the capsule 10 are configured to stack with the adjacent capsule of the same configuration.

By having different maximum distances (d1, d2, d3) extending above the sealing plane, a natural cavity is formed between the first compartment 11, the second compartment 12 and the third compartment 13. The cavity is located between two planes parallel to and above the sealing plane, a first plane at a distance equal to the first distance (d1) and a second plane at a distance equal to the greatest distance between the third distance (d3) and the second distance (d2). Being the first distance (d1) greater than the third distance (d3) and the second distance (d2), the first compartment 11 sticks out the second plane until the first plane, forming a bulge.

When the cavity of the capsule 10 is stacked with the first compartment bulge of an adjacent capsule, the capsule 10 and adjacent capsule fit together complementary, allowing minimal wasted space in between when stacking. Other considerations, such as the distances of the bulge in each compartment, shape of compartments, size and configuration of sealing lines, etc. can be configured to promote the stacking.

### Method for Preparation of Composition

In a second aspect, the invention provides a method for preparation of a product according to the first aspect of the invention. The steps (iii) and (iv), related to filling the recesses with compositions, may take place in any order ((iii) followed by (iv), or (iv) followed by (iii)), or may take place simultaneously. In case a preferred product containing three compartments is prepared, then the method comprises the following step (v):
(v) filling a third recess with a third composition, wherein the third composition is a powdered composition or a liquid or a gel.

The original step (v), related to sealing of a second sheet of film to the first sheet of film, then becomes step (vi).

In such case with a preferred step (v), the method steps (iii), (iv), and (v), can be executed in any order (e.g. (iii)-(iv)-(v), (iii)-(v)-(iv), (iv)-(iii)-(v), (iv)-(v)-(iii), (v)-(iii)-(iv), (v)-(iv)-(iii)). Alternatively, two of the three steps or all three steps may be performed simultaneously. When two of the three steps are performed simultaneously, this may be any two of the three steps ((iii) and (iv), or (iii) and (v), or (iv) and (v)). The two simultaneous steps may either be preceded or followed by the other step.

Any preferred aspect disclosed herein in relation to the first aspect of the invention, can be applied to the second aspect of the invention, mutatis mutandis.

The powdered first composition of the invention can be prepared by a standard process for making powdered detergents: dry mixing the various dry ingredients into a homogeneous mixture, and subsequently spraying the optional liquid nonionic surfactant (if present in the first composition) on the dry powder. Such powder with optional absorbed nonionic surfactant is then again mixed into a homogeneous mixture.

The liquid or gel second composition of the invention can be prepared by mixing the various ingredients (in liquid or dissolved form) into a homogeneous liquid mixture.

### Method for Cleaning

In a third aspect, the invention provides a method for cleaning bleachable stains, preferably tea and/or coffee stains, in a machine dishwashing process, using a product according to the first aspect of the invention. Preferably the invention provides a method for cleaning tea stains. The product of the invention is also suitable for removal of other stains, regularly found on dishes, including proteinaceous, starchy, and fatty stains.

Preferably, the method includes placing the capsule in the drum or dosing drawer or any dosing device of a (dish)washing machine prior to commencement of a wash cycle.

Preferably, the pH of the wash liquor during the machine dishwashing process has a pH ranging from 10 to 11 (at the temperature of the washing process), more preferably ranging from 10.4 to 11, most preferred ranging from 10.5 to 11.

The capsules are particularly suitable for use in dishwashing and (substrate) washing machines amongst other applications. They can also be used in manual dishwashing. In use the capsules are preferably, and conveniently, placed directly into the liquid which will form the wash liquor or into the area where this liquid will be introduced. The capsule dissolves on contact with the liquid, thereby releasing the detergent composition from the separate compartments and allowing them to form the desired wash liquor.

Any preferred aspect disclosed herein in relation to the first aspect of the invention, can be applied to the third aspect of the invention, mutatis mutandis.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

### EXAMPLES

### Example 1—Products of the Invention

Two different powder (first) compositions according to the invention were prepared, as well as a comparative powder, with the following compositions:

TABLE 1
Compositions of powders as first compositions

| | Powder 1 | | Powder 2 | | Powder 3 (comparative) | |
|---|---|---|---|---|---|---|
| | Conc. | | Conc. | | Conc. | |
| | active | amount | active | amount | active | amount |
| | ingr. | in wash | ingr. | in wash | ingr. | in wash |
| | [wt %] | [gram] | [wt %] | [gram] | [wt %] | [gram] |
| Sodium citrate dihydrate | 10.36 | 1.14 | 9.5 | 1.14 | 11.4 | 1.14 |
| Sodium percarbonate | 17.77 | 1.96 | 16.29 | 1.96 | 19.55 | 1.96 |
| TAED | — | — | — | — | 1.44 ^{#} | 0.144 ^{#} |
| Manganese catalyst | 0.06 | 0.0063 | 0.05 | 0.0063 | 0.04 ^{#} | 0.0040 ^{#} |
| Hydrous sodium silicate ^{&} | 4.91 | 0.54 | 4.50 | 0.54 | 1.35 | 0.14 |
| Sodium disilicate ^{$} | 0.91 | 0.10 | 0.83 | 0.10 | 1.00 | 0.10 |
| Sodium carbonate | 44.76 | 4.92 | 49.37 | 5.92 | 42.78 | 4.28 |
| Nonionic surfactant | 2.50 | 0.27 | 2.29 | 0.27 | 2.75 | 0.27 |
| Sulphonated polymer | 3.91 | 0.43 | 3.59 | 0.43 | 4.31 | 0.43 |
| Phosphonate | 0.69 | 0.08 | 0.63 | 0.08 | 0.76 | 0.08 |
| Protease and | 6.27 | 0.69 | 5.75 | 0.69 | 8.86 | 0.67 |
| amylase granules | | | | | | |
| Minors, impurities * | 7.86 | 0.06 | 7.21 | 0.06 | 5.75 | 0.06 |
| Total | | 11 | | 12 | | 10 |

^{#} Manganese catalyst and TAED added as a co-granule containing both compounds
^{&} Britesil H ex PQ Corporation
^{$} SKS-6 ex WeylChem
* impurities: e.g. carrier materials coming naturally with the raw materials

These compositions were prepared by mixing dry raw material powders into a homogeneous powder mixture, and subsequently spraying it with the liquid nonionic surfactant to prepare homogeneous powder mixtures with nonionic absorbed in the powders.

Two different liquid (second) compositions according to the invention were prepared, with the following compositions:

TABLE 2
Compositions of liquids as second compositions

| | Liquid 4 | | Liquid 5 | |
|---|---|---|---|---|
| | Concentration | | Concentration as | |
| | as active | Amount in | active ingredient | Amount in |
| | ingredient [wt %] | wash [gram] | [wt %] | wash [gram] |
| MGDA solution ^{#} | | | 18.17 | 0.98 |
| GLDA solution * | 21.35 | 1.15 | | |
| Citric acid | 8.2 | 0.44 | 8.2 | 0.44 |
| monohydrate | | | | |
| Nonionic surfactant | 3.41 | 0.18 | 3.41 | 0.18 |
| Monoethanolamine | 5.91 | 0.32 | 5.91 | 0.32 |
| Phosphonate | 0.44 | 0.02 | 0.44 | 0.02 |
| Sulphonated | 5.86 | 0.32 | 5.86 | 0.32 |
| Polymer | | | | |
| Minors/others | 2.47 | 0.13 | 2.47 | 0.13 |
| Water | 9.16 | 2.83 | 9.16 | 2.83 |
| Total | | 5.4 | | 5.4 |

^{#} Trilon M Liquid, 40% MGDA-Na₃ ex BASF
* Dissolvine GL-47-S, 47% GLDA-Na₄ ex Nouryon

The powdered and liquid compositions were added to capsules according to the invention as 4 different configurations:

| | | |
|---|---|---|
| Capsule 1: | Powder 1 | Liquid 4 |
| Capsule 2: | Powder 1 | Liquid 5 |
| Capsule 3: | Powder 2 | Liquid 4 |
| Capsule 4: | Powder 2 | Liquid 6 |

And a comparative capsule was prepared by combining Powder 3 and Liquid 4.

The capsules were made from polyvinylalcohol, each capsule weighing 0.7 gram, and having two compartments.

Cleaning tests were conducted with each capsule. Each capsule was put into the drawer of a standard household dishwashing machine (Miele GSL), as per IKW 2016 standard cleaning method. For each composition, a cleaning program was run: standard 45° C. program with 8 minute hold. Water was 35° FH/25° temporary hardness.

Tiles with standardized tea soil, were used to test the cleaning effect of each composition. These standardized tiles (type DM-14) were obtained from Center For Testmaterials BV (Vlaardingen, the Netherlands). For each soil, three tiles were included in the wash in different positions in the dishwasher. After the cleaning run, each tile was measured once using a spectrometer (DigiEye). The tiles were measured before and after the wash, and the L-a-b values were calculated and then assessed using a statistical package.

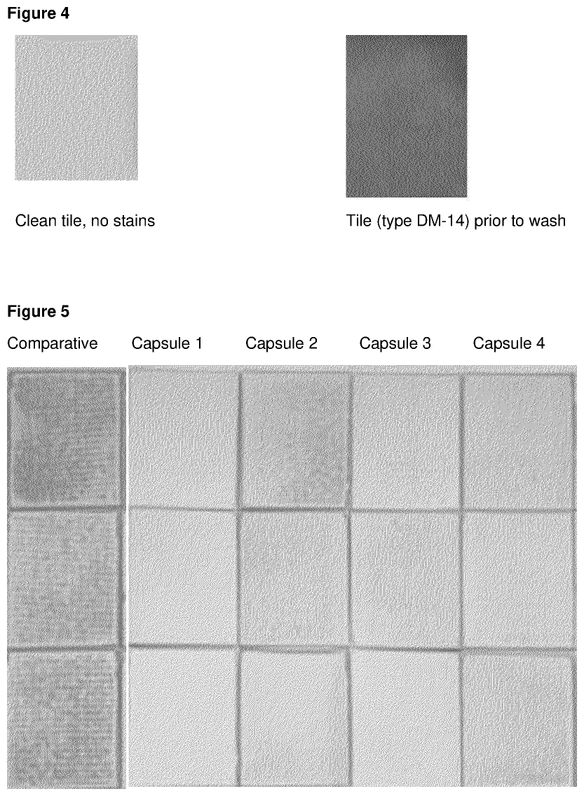

Images of the tiles are shown in FIGS. 4 and 5. FIG. 4 shows an empty tile without soil (left) and a standardized tile with tea soil before cleaning (right).

FIG. 5 shows images of each of the tiles after the cleaning process. Additionally, the cleaning performance for each capsule was calculated from the three tiles for each capsule, and expressed as the average value (least square mean, determined using the DigiEye measurements). The higher the cleaning value, the better the cleaning. The results are shown in table 3.

TABLE 3
Measurement of cleaning data (as removal percentage)
for tiles for each of the capsules

| | Average (least | | | | |
|---|---|---|---|---|---|
| | square mean) | | | | |
| Capsule | removal % | Significance | | | |
| Comparative capsule | 82.3 | | | | D |
| Capsule 1 | 92.3 | A | | | |
| Capsule 2 | 88.0 | A | B | C | |
| Capsule 3 | 91.4 | A | | | |
| Capsule 4 | 90.7 | A | B | | |

The standard error for each set of 3 measurement data points, based on 3 tiles, is 1.067.

The significance between the various data points has been calculated, as determined using a standard statistical program, Tukey HSD. Capsules linked by the same letter are not statistically different. This shows that the capsules 1 to 4 according to the invention perform statistically significant better than the comparative composition.

The cleaning values in the table above confirm the images in FIG. 5. The images and the measurement values show that the compositions according to the invention provide an excellent cleaning performance on tea stains, which is better than the comparative capsule.

### Example 2—Optimising TAED and Manganese-Catalyst

A base powder was prepared, having the following composition:

TABLE 4
Composition base powder, per dose, for use in next experiment.

| | Dose per wash [gram] |
|---|---|
| Sodium carbonate | 4.28 |
| Trisodium citrate | 1.14 |
| anhydrous | |
| Hydrous sodium silicate | 0.14 |
| Sodium disilicate | 0.10 |
| total | 5.65 |

This powdered composition was prepared by mixing the dry raw materials into a homogeneous mixture.

Sodium percarbonate, MGDA, GLDA, TAED, and manganese catalyst (same materials as in example 1) were added in various amounts to this base powder, to test bleaching performance. This experiment was designed to test the effect of the concentration of manganese catalyst and TAED. The amount of hydrous sodium silicate and sodium disilicate has not been optimized (like in example 1), and therefore the dose per wash is lower than in example 1. Nevertheless the effect of manganese catalyst and TAED is clearly present. Compositions and tea removal are given in the following table:

TABLE 5
Compositions of powders to test influence of manganese catalyst (MnCat) and TAED.

| | | | | | | | | | | | | | Mean Tea |
|---|---|---|---|---|---|---|---|---|---|---|---|---|---|
| | Base | | | | | | | | | | | | Removal |
| | powder | | | | | | | | | | | | (Least |
| Experiment | (table 4) | | Percarbonate | | GLDA | | MGDA | | MnCat | | TAED | | square mean) |
| 1 | 5.65 | g | 1.96 | g | 0 | g | 0.62 | g | 0.004 | g | 0 | g | 30.46 |
| 2 | 5.65 | g | 1.96 | g | 0.63 | g | 0 | g | 0.004 | g | 0 | g | 30.42 |
| 3 | 5.65 | g | 1.96 | g | 0 | g | 0.62 | g | 0.004 | g | 0.14 | g | 31.03 |
| 4 | 5.65 | g | 1.96 | g | 0 | g | 0.62 | g | 0.011 | g | 0 | g | 30.97 |
| 5 | 5.65 | g | 1.96 | g | 0 | g | 0.62 | g | 0.023 | g | 0 | g | 29.90 |
| 6 | 5.65 | g | 1.96 | g | O | g | 0.62 | g | 0.034 | g | 0 | g | 27.12 |
| 8 | 5.65 | g | 1.96 | g | 0 | g | 0.62 | g | 0.011 | g | 0.22 | g | 31.94 |
| 9 | 5.65 | g | 1.96 | g | 0 | g | 0.62 | g | 0.011 | g | 0.29 | g | 31.03 |
| 10 | 5.65 | g | 1.96 | g | 0 | g | 0.62 | g | 0.011 | g | 0.43 | g | 32.30 |
| 11 | 5.65 | g | 1.96 | g | 0 | g | 0.62 | g | 0.023 | g | 0.22 | g | 30.74 |
| 12 | 5.65 | g | 1.96 | g | 0 | g | 0.62 | g | 0.023 | g | 0.29 | g | 31.05 |
| 13 | 5.65 | g | 1.96 | g | 0 | g | 0.62 | g | 0.023 | g | 0.43 | g | 32.02 |
| 14 | 5.65 | g | 1.96 | g | 0 | g | 0.62 | g | 0.023 | g | 0.92 | g | 31.56 |
| 15 | 5.65 | g | 1.96 | g | 0 | g | 0.62 | g | 0.023 | g | 1.84 | g | 31.70 |

The following methodology was applied to test the performance of these compositions:
5 liter water in beaker with added formulation as per experiments above;
3 standard tea tiles (same as in example 1) were immersed in the beaker;
tiles remained suspended in solution with agitation for 10 mins at 40° C.;
tiles were removed, rinsed, dried then stain removal measured, as below.

This experiment simulates a product of the invention, with base powder, sodium percarbonate, manganese catalyst and TAED in the first composition, and the GLDA or MGDA in the second composition.

The higher the tea removal value, the better the stain removal. The measurements, and determination of mean value were done as in example 1.

These experiments show that:
Increasing the level of manganese catalyst (without TAED present) decreases bleach performance (see experiments 4, 5, 6);
There is a maximum level of manganese catalyst when TAED absent, a performance plateaux is achieved (see experiments 1, 2, 4, 5, 6);
Use of both manganese catalyst and TAED has a minor/non-significant influence on bleach performance

These experiments show that TAED is not required to obtain good cleaning results, when the amounts of carbonates, silicates, MGDA or GLDA, and bleaching compound and manganese catalyst have been optimised. In absolute terms, in case both TAED and manganese catalyst are present, then the tea stain removal is best. However, these values are not significantly better than the tea stain removal in case no TAED is present.

Therefore, these experiments show that TAED is not required, in case the amounts of other ingredient have been optimised to obtain good cleaning performance.

1. A product for machine dishwashing, comprising a capsule containing two or more compartments, comprising
a first compartment containing a first composition;
a second compartment containing a second composition;
wherein the first composition is a powdered composition, comprising, based on the weight of the first composition:
an alkali metal carbonate, at a concentration ranging from 25% to 60% by weight;
a bleach component, preferably sodium percarbonate, at a concentration ranging from 15% to 25% by weight;
sodium silicate and/or sodium disilicate, at a concentration ranging from 4% to 10% by weight;
a bleach catalyst, preferably a manganese-containing bleach catalyst, at a concentration ranging from 0.04% to 0.1% by weight;
tetraacetylethylenediamine (TAED) at a concentration from 0 to maximally 0.1% by weight;
wherein the second composition is a liquid or a gel, comprising, based on the weight of the second composition:
nonionic surfactant, at a concentration ranging from 1% to 10% by weight;
one or more builder compounds, and wherein the concentration of builder compounds ranges from 15% to 25% by weight;
and water.

2. A product according to claim 1, wherein the first composition is free from tetraacetylethylenediamine (TAED).

3. A product according to claim 1, wherein the first composition further comprises an alkali metal citrate salt at a concentration ranging from 5% to 15% by weight of the first composition.

4. A product according to claim 1, wherein the concentration of sodium silicate and/or sodium disilicate in the first composition ranges from 4.5% to 8% by weight of the first composition.

5. A product according to claim 1, wherein the first composition comprises sodium silicate at a concentration ranging from 2.5% to 9.5% by weight, and sodium disilicate at a concentration ranging from 0.5% to 1.5% by weight of the first composition.

6. A product according to claim 1, wherein the aminocarboxylic acids are selected from tetrasodium salt of glutamic acid, N,N-diacetic acid (GLDA) and trisodium salt of methylglycinediacetic acid (MGDA).

7. A product according to claim 1, wherein in the first composition the weight ratio between alkali metal carbonate on the one hand and sodium silicate and/or sodium disilicate on the other hand ranges from 2.5 to 12.

8. A product according to claim 1, wherein the first compartment and the second compartment are separated from each other in a sealing plane.

9. A product according to claim 8, comprising a capsule containing three compartments, wherein the third compartment contains a third composition; and wherein the first and the second and the third compartment are separated from each other in a sealing plane.

10. A product according to claim 9, wherein the first compartment is larger than each of the second and third compartments.

11. A product according to claim 10, wherein the first compartment has a generally semi-circular shape in plan view, wherein that plan view of the shape is a half or part of a circle, and wherein a straight line portion of the semi-circular compartment is located on a side of the capsule and extends between two adjacent corners of the capsule.

12. A product according to claim 1, wherein the weight of the first composition in the first compartment ranges from 8 to 13 gram.

13. A composition according to claim 1, wherein the weight of the second composition in the second compartment ranges from 1.5 to 10 gram.

14. A method for preparation of a product according to claim 1, comprising the steps:
(i) placing a first sheet of water-soluble film over a mould comprising cavities;
(ii) heating and applying vacuum to the film to mould the film into the cavities and hold it in place to form corresponding recesses in the film;
(iii) filling a first recess with a first composition, wherein the first composition is a powdered composition, comprising, based on the weight of the first composition:
an alkali metal carbonate, preferably sodium carbonate, at a concentration ranging from 25% to 60% by weight;
a bleach component, preferably sodium percarbonate, at a concentration ranging from 15% to 25% by weight;
sodium silicate and/or sodium disilicate, at a concentration ranging from 4% to 10% by weight;
a bleach catalyst, preferably a manganese-containing bleach catalyst, at a concentration ranging from 0.04% to 0.1% by weight;
tetraacetylethylenediamine (TAED) at a concentration from 0 to maximally 0.1% by weight;
(iv) filling a second recess with a second composition, wherein the second composition is a liquid or a gel, comprising, based on the weight of the second composition:
nonionic surfactant, at a concentration ranging from 1% to 10% by weight;
one or more builder compounds, and wherein the concentration of builder compounds ranges from 15% to 25% by weight;
and water;
(v) sealing a second sheet of film to the first sheet of film across the formed recesses to produce a capsule having at least two compartments separated from each other by a continuous internal sealing web.

15. A method for cleaning bleachable stains, preferably tea and/or coffee stains, in a machine dishwashing process, using a product according to claim 1.

16. The product of claim 1, wherein the an alkali metal carbonate is sodium carbonate and/or the one or more builder compounds is selected from one or more aminocarboxylic acids.

17. The product of claim 1, wherein the alkali metal carbonate is at a concentration ranging from 30% to 60% by weight.
